(19) United States
(12) Patent Application Publication
(10) Pub. No.: US 2020/0143684 A1
(43) Pub. Date: May 7, 2020

(54) Vehicle Threat Mitigation Technologies

(71) Applicant: Michael A. Halem, New York, NY (US)

(72) Inventor: Michael A. Halem, New York, NY (US)

(21) Appl. No.: 16/675,797

(22) Filed: Nov. 6, 2019

Related U.S. Application Data
(60) Provisional application No. 62/756,775, filed on Nov. 7, 2018.

(51) Int. Cl. G08G 1/16; G07C 5/00

(52) U.S. Cl. CPC G08G 1/166; G07C 5/008; G08G 1/161

(57) ABSTRACT

A threat mitigation device, uses a camera and/or sensor system, obtaining multiple camera and/or sensor views of multiple areas around a movable vehicle or person, including other vehicles or persons around the movable vehicle or person. Plural different sensors may be used for sensing plural different actions around the vehicle or person. A driver display displaying information to a driver of the vehicle or the person. A threat display, displays information to at least one driver outside the vehicle. A processor, receives information from the camera system, and the sensors, and determines a collision risk from the other vehicles or persons, and if the collision risk is greater than a certain level, issues a warning to the driver of the vehicle or person and/or also to a driver of at least one of the other vehicles or persons.

### TECHNICAL FIELD

Generally, the present disclosure relates to a device or network of devices to mitigate the collision threat of vehicles and other moving objects to other vehicles and other objects moving or stationary.

### BACKGROUND

In the present disclosure, where a document, an act and/or an item of knowledge is referred to and/or discussed, then such reference and/or discussion is not an admission that the document, the act and/or the item of knowledge and/or any combination thereof was at the priority date, publicly available, known to the public, part of common general knowledge and/or otherwise constitutes prior art under the applicable statutory provisions; and/or is known to be relevant to an attempt to solve any problem with which the present disclosure may be concerned with. Further, nothing is disclaimed.

In surface transportation, over 1.25 million people are killed and over 20 million are injured each year by the collision of moving vehicles with other vehicles or objects in what are commonly called “accidents”. Such accidents cost most countries 3% of GDP. (Source: World Health Organization Fact Sheet, 19 Feb. 2018.). 94% of U.S. road accidents are due to driver error. (Source: NHTSA Traffic Safety Facts, February 2015.) As such, most “accidents” are preventable. The failure of governments to mitigate such harm to people, in the presence of economically reasonable means to do so, could be considered as intentional negligence by governments around the world and society as a whole.

In 2015, 818 cyclists were killed and an estimated 45,000 were injured in motor vehicle crashes in the United States. (Source: NHTSA 2015 Traffic Safety Fact Sheet Bicyclists & Other Cyclists, March 2017.) In 2015, there were 5,376 pedestrians killed and an estimated 70,000 injured in traffic crashes in the United States. (Source: NHTSA 2015 Pedestrian Traffic Safety Fact Sheet, February 2017.) As a cyclist or pedestrian is alone in facing risk of bodily harm from a collision with an automobile, truck, or bus, the lack of self-preservation motivation by an aggressive or negligent vehicle driver, combined with a near total lack of accountability in risky vehicle operation (if there is not an actual accident), presents a problem for governments around the world and society as a whole.

The addition of publicly rentable and privately-owned bicycles and scooters, high velocity “E-Bikes”, and other such newly popular conveyances will possibly increase the bicycle, scooter, and pedestrian death and injury statistics in the future.

### Definitions

The following definitions will be used in the present disclosure for the convenience of the reader.

An “XCraft” is defined as, without limitation, a vehicle, bicycle, motorcycle, boat, ship, ridable animal, pedestrian, runner, skateboard, scooter (whether propelled by a human, an electric motor, or an engine), e-bike, electric bike, engine powered bike, human propelled wheelchair, electric wheelchair, engine powered wheel chair, spacecraft, flying car, flying platform, or any type of aircraft. XCraft is defined as both singular and plural and may be used with or without the ending “s” as XCraft or XCrafts may be grammatically agreeable to readers.

A “Pilot” is defined as, without limitation, a driver, rider, pedestrian, robot, boat pilot, aircraft pilot, captain, or any other person, computing machinery, algorithm, algorithms, artificial intelligence (“AI”), or other thing that controls the movement, speed, position, velocity, acceleration, and/or kinematics of an XCraft in space and time.

A “Threat” or “Threat XCraft” is defined as, without limitation, one or more XCraft whether stationary or moving that could potentially hit, collide, damage, upset, push over, injure, or kill an XCraft or its occupants, all such forms of harm being termed “Damage”. Threat and Threat XCraft is both singular and plural and may be used with or without the ending “s”, as in Threats as may be grammatically agreeable to readers.

A “Threat Mitigation Device”, “Device”, or “Threat Mitigation System” is defined as, without limitation, a device or collection of devices on an XCraft to mitigate and/or defend an XCraft from Threat XCraft.

A “Defended XCraft” or “Defense XCraft” is defined as, without limitation, an XCraft that is defending against Threat XCraft(s) by the use of a Threat Mitigation Device. The term Defended XCraft and Defense XCraft will be used interchangeably as is agreeable to readers.

“Kinematics” is defined as the kinematic description of the position and motion of an object in any coordinate frame including earth centric or any XCraft centric frame; including as an example the frame of an XCraft's center of mass in Cartesian coordinates by example x, y, z, being taking together as the position vector of any object, velocity vector, the acceleration vector, the first derivative of acceleration vector, and any higher derivatives or similar information needed to describe the current and future state through time and space of any object. Kinematics definition is further extended to include any known or planned changes to the kinematic state that would result in a future kinematic state at variance with the current state; including for example future planned braking, acceleration or turning to follow a road, follow other vehicles, or to comply with a traffic signal that has been communicated to the Threat Mitigation Device by the XCraft Pilot or other Threat XCraft.

“V2V” is an abbreviation for “Vehicle to Vehicle” communication of information useful to the safety of the vehicles. “V2I” is an abbreviation for “Vehicle to Infrastructure” data communications of information useful to the safety of the vehicles. “V2X” is an abbreviation for V2V and/or V2I. Of note is that there are some pre-existing V2V, V2X, and V2I communications standards that preceded the invention of the present disclosure. The present disclosure may use existing standards or invent new means to accomplish that which has not already been invented.

### SUMMARY

The present disclosure addresses the above problems, and may also prove useful in addressing other problems and deficiencies in a number of technical areas. Therefore, the claims, as recited below, should not necessarily be construed as limited to addressing any of the particular problems or deficiencies discussed herein.

An embodiment describes a Threat Mitigation Device that provides situational awareness of Threat(s) to the Pilot of a Defended XCraft, thereby allowing the Pilot to mitigate or otherwise avoid Damage. In an embodiment, the Threat Mitigation Device may communicate to the Pilot of its XCraft via warning audio messages such as “Threat 5 o'clock, 20 meters, closing fast”. The Threat Mitigation Device may also communicate with external Threat XCraft and their Pilot(s), including by a “Virtual Tail Display” which may function as a superset of the functions of a braking light, a taillight, and an intelligent warning information display. One embodiment may show a brake-light image plus text displaying a message about the Threatening behavior, such as “Please Back Off 1 Car Length”. Another embodiment may display a moving or stationary “eye” symbolic icon indicating the Threat(s) are being watched, tracked and recorded for future law enforcement use.

The Threat Mitigation Device may also have a “Virtual Horn” which may beep, ring, or send verbal messages either omnidirectionally, or in other example embodiments, directionally focused towards the Pilot of the Threat XCraft. (e.g. “Yellow Taxi—Please Don't Tailgate”).

### BRIEF DESCRIPTION OF THE DRAWINGS

The accompanying drawings illustrate example embodiments of the present disclosure. Such drawings are not to be construed as necessarily limiting the present disclosure. Like numbers and/or similar numbering scheme can refer to like and/or similar elements throughout. All example embodiments are mere example and the invention is not limited to any such embodiment, but rather encompasses all embodiments as explained in the “Detailed Description of Embodiments” section below.

FIG. 1 shows a side view of an example embodiment of the Defended XCraft as a bicycle, being approached by an example embodiment of a Threat XCraft (a Taxi), and showing the relative position of different example embodiment equipment that would comprise an example Threat Mitigation System.

FIG. 2 is an example embodiment of a Device Block Diagram of the Threat Mitigation System showing generally example components that would comprise the System, together with connections showing the path of data, signals, or other information.

FIG. 3 is an example embodiment of the Device main loop showing processing steps, conditional rules, and outputs of the Device.

FIG. 4 is an example of the Threat Mitigation System recording of dangerous and illegal Threat behavior, with possible subsequent legal prosecution, regulatory complaint to authorities, and civil action against dangerous and illegal Threat pilots and XCraft owners.

### DETAILED DESCRIPTION

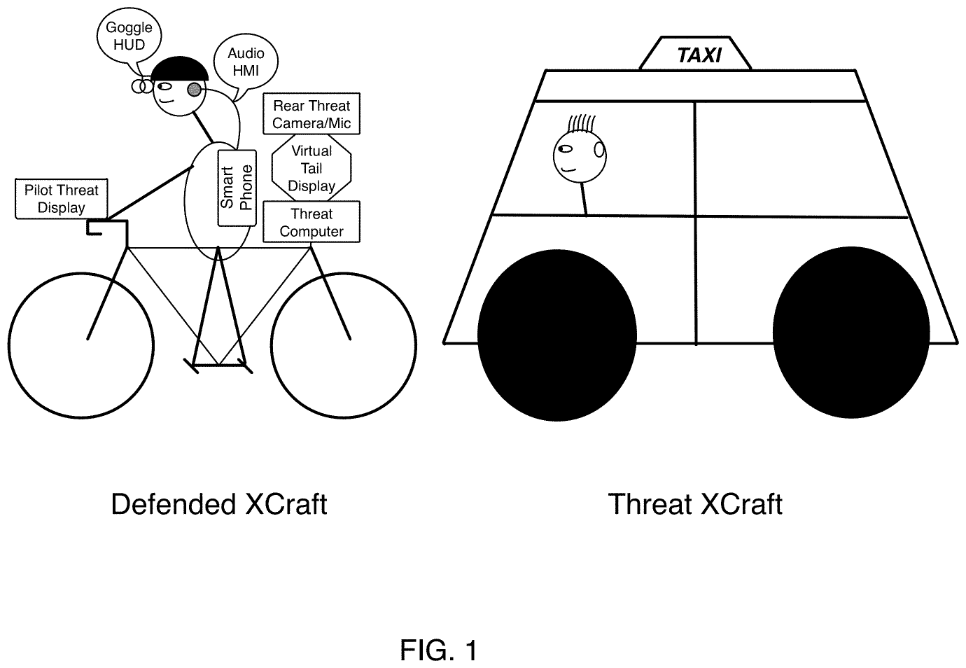

A first embodiment is shown in FIG. 1, where the Device is a bicycle, outfitted with the hardware described herein. This is used to warn and protect the driver against threats, to communicate with threats to try and mitigate the threats by communication, and to record information about the threats for possible further action if needed.

In other embodiments, this can be installed on other vehicles (i.e. XCraft).

The device, shown generally as 100, includes a rear facing camera 105, front facing camera 110, and/or side cameras. Each camera may include one or multiple cameras. In addition, there can be one or multiple 360° field of view cameras.

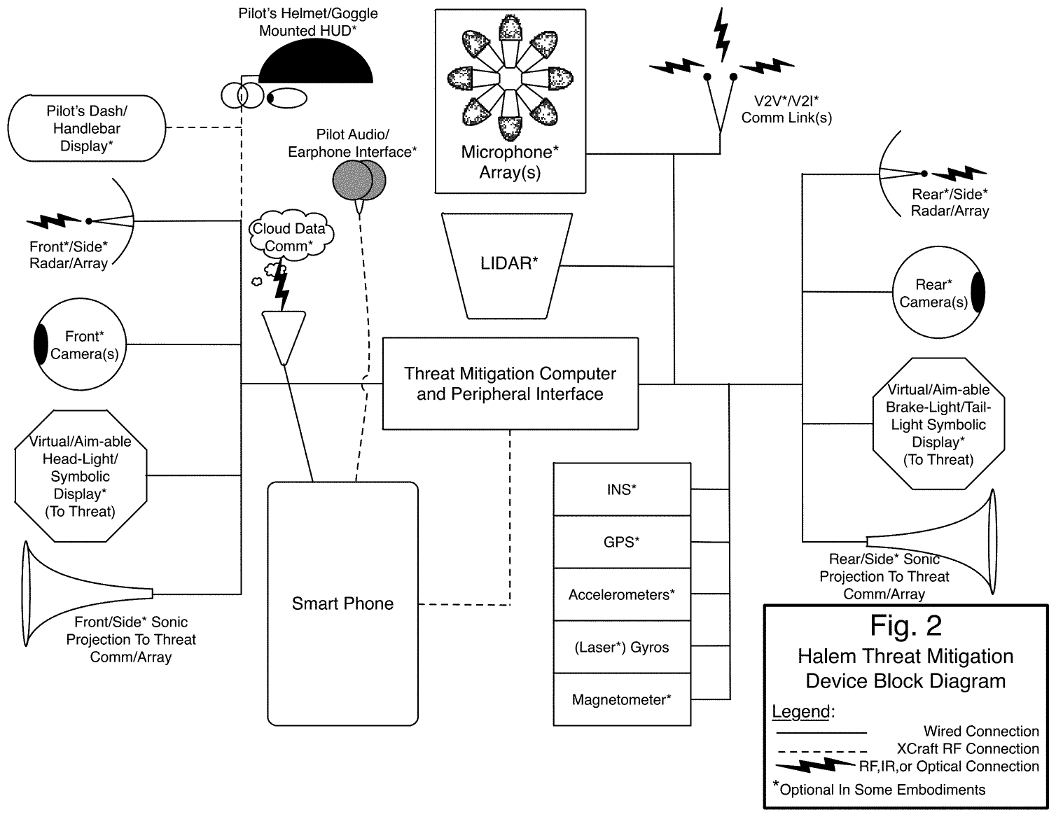

The vehicle is also equipped with a number of other sensor devices. A microphone array 106 can receive sound from any of a number of different directions. Of note, the drawing of the microphone array in FIG. 1 and FIG. 2 is for illustrative purposes at an orientation that facilitates the reader visualizing the microphone array in the illustration; however the size, shape, orientation, and number of microphones in the microphone sensors of the invention may be any including 1 or none. Device internally integrated sensors are shown generically as 120 in FIG. 2, and include other electromagnetic sensors, microphones, GPS receivers, accelerometers, gyroscopes, magnetic field sensors, magnetometers, and/or magnetic compasses. Other sensors which may be integrated or may be separate components include radars shown as 205 and 206 in FIG. 2, LIDARs (laser or light detection and ranging sensors, sometimes spelled in other literature as “lidar” or Lidar”) shown as 201 in FIG. 2, and other electromagnetic spectrum sensors.

All of the information received by the sensors is accumulated by and processed by a threat mitigation computer 130 which gets all the information and processes the information as described herein. The threat mitigation computer can include a programmable computer comprising one or multiple CPUs, GPUs, quantum computers, quantum computing coprocessors, analog computers, analog coprocessors, RAM memory, ROM memory, hard disk, solid state disk, flash, or equivalent long term storage. In one embodiment, the threat computer is a standalone computer. In other embodiments, the threat computer can be instructions that are carried out on a portable phone running an app, or on other kinds of computer such as a tablet computer or personal computer.

The information is communicated both to the Defended XCraft Pilot (e.g. the cyclist, driver, or pedestrian), and to the outside world. To communicate to other XCraft pilots (e.g. drivers of vehicles behind the Defended XCraft), a virtual tail display 140 is formed by a programmable rear facing light display, and an interface to the display. The interface to the Defended XCraft Pilot can be via audio headphone cable, USB, ethernet, fiberoptic cable, Bluetooth, WiFi, cellular, microwave, visible light, infrared light, ultraviolet light, RF or other connection. The interface to the tail display can alternatively be via wireless, such as Bluetooth, WiFi, cellular, RF, microwave, optical, IR, visible light, or non-visible light. As explained herein, the information may be communicated to other vehicles, using messages, by example, such as “you are following too closely”.

The information is also communicated to the operator (i.e. the Pilot), via a user interface. In FIG. 1, the UI is formed of display 150, and can also include another human or computer interface device to the Pilot including a smart phone 151, earphones 152, HUD 153 or other helmet mounted display, head mounted display like Google Glass, direct neuron stimulation, tablet, screen or other display; all programmed to carry out the functions described herein.

For example, in the embodiment shown in FIG. 2, the front camera 110 and the rear camera 105 both can communicate with Threat Mitigation Computer. The Threat Mitigation Computer also receives information from the microphone array 106, from the LIDAR device 201, front and side radar arrays 205, and from the sensors 120. Any of this information can be sent to the threat mitigation computer 130 via wired communication, or wireless communications of the types described herein. The intention of the present disclosure is that the function of the Special Purpose computer as programmed via Software of the type described herein is part of an embodiment.

Embodiments can include an AI, algorithmic, neural network, probabilistic, statistical or heuristic module that predicts via Kinematics and current and/or past Threat behavior, the future risks to the XCraft and communicate this via the Pilot Interface warnings and suggest safety avoidance track or braking modifications. For example, this may include a predictive warning interface, which predicts when another automobile (i.e. Threat XCraft) is approaching the Defended XCraft at too fast a speed, when someone or something (i.e. a Threat XCraft) is following too closely, or other similar threat conditions. In addition, this may detect when the user is approaching a barrier or other stationary object too fast, or is going off course. Examples of such warnings include, without limitation, “Turn Right This Street”, “Get Off of the Road Now to the Right”, or “Brake Now”. This can be displayed or communicated to the driver (i.e. the XCraft Pilot).

An embodiment communicates to the Pilot sufficient information to identify and safely avoid any Threat within the sensor or external V2X communication range of the Device. Such communication may be via earphones, headphones, or a speaker to the Pilot with a warning such as “Check 6”, “Threat Rear Right 20”, “3.5 seconds to Impact”, beeping or tone audio frequency, a beeping or tone of growing intensity, stereophonic beep direction indicating Threat direction (i.e. Left or Right), or such other warning as a Pilot may find useful to alter to and avoid the Threat. Embodiments are designed to work without V2X using the non-V2X available information from its sensors, but other embodiments integrate V2X information into their design.

Embodiments can include a light, screen, laser, or display 140 and/or 240; or external sound like a horn, bell, or sonic projection device 210 or 211, whether directionally focused or omnidirectionally transmitted, or may utilize other mechanism(s) of communicating visually or audibly to other Pilots of other XCraft the location of Device's XCraft, and to also indicate the intention and Kinematics of the XCraft including stopping, turning left or right, or positive acceleration.

Embodiments can include a rear facing display 140 where the brake-light(s) had been on conventional automobiles of the year 2010. In addition to functioning as virtual turn indicators and a virtual brake-light, (whether on XCraft that have traditionally used conventional brake lights and turn signals) the rear facing display may indicate to the threat that it is being “watched” and recorded. For example, the threat may be displayed an icon such as an eye icon or photo of the threat itself, such as a photo of what the camera(s) is seeing, a photo of the threat's license plate number, or other warning information, so that the threat becomes aware that any unsafe maneuvers of the Threat XCraft have been recorded with sufficient information to identify the Pilot and/or Owner of the Threat XCraft.

Embodiments can use the forward-facing camera(s) which may detect and warn the Pilot of impending collisions with other XCraft (including pedestrians) in the Pilot's XCrafts kinematic and/or controlled predicted path. The Device may use prediction techniques to estimate and warn against the risk of forward collision by the XCraft Pilot.

Embodiments can include the forward-facing camera(s) to record illegally parked XCraft, in the road, bike lane, or sidewalk, creating a hazard for cyclists, pedestrians, or other motorized XCraft.

Embodiments can include the forward-facing camera(s) whether infrared, visible, or ultraviolet, a radar, LIDAR, a flash illumination system or other such system to sense, detect, and predict the potential risk of impact by the Defended XCraft with a suddenly opened parked vehicle door (sometimes called “dooring” by cyclists), or the potential risk of a pedestrian stepping into the path of the Defended XCraft, even if the pedestrian should surprisingly or illegally execute such movement into the street or bike lane. The forward facing camera(s) may use image recognition and/or infrared thermal image technology to detect drivers or passengers within parked XCraft that may open the door, and to record these actions and/or send warning to those drivers or passengers and to the Defended XCraft Pilot before the opening of the door.

Embodiments can include a horn, bell, or front sonic projection device 210 whether omnidirectional or direction, a horn, bell, or rear sonic projection device 211 whether omnidirectional or directional, to warn potential pedestrians, parked Threat XCraft passengers and drivers, and other XCraft Pilots of the future movement of the Defended XCraft into a position where a negligent or surprising movement could create a collision. The XCraft front head light, strobe light, laser light, or symbolic display 240 may be programmed to strobe, flash, move, or blink to catch the eye of and thereby alert potential pedestrians, parked Threat XCraft passengers and drivers exiting their vehicle, of the future movement of the Defense XCraft into a position where a negligent or surprising move could create a collision.

The Threat XCraft license plate, image, audio, transponder ID, or V2V digital identification may be recorded by the Device. Any illegal, negligent and/or unsafe (“Threatening”) piloting behavior, such as, but not limited to passing too close, tailgating, honking while tailgating, flashing bright lights while tailgating, cutting off, road-rage, and/or brandishing a weapon, may be referred to a law enforcement, administrative, or civil enforcement team via communications 250 to a Cloud database server. Such enforcement responsibility may go to police, city, state or national traffic safety authorities, civil government, safety planners, and/or a private or public law firm which may document the complaint against a dangerous or illegal XCraft behavior; such enforcement team being termed an “Enforcement Team”. The Enforcement Team costs may be paid for via a user subscription, a contingency fee arrangement, a one off fee per incident arrangement, tax payer paid enforcement, a pro bono socially responsible legal charity contribution, or other means..

The Enforcement Team embodiments may include traffic safety engineers whether private, non-profit, or municipal, who may predict and respond to the redesign of roadways, sidewalks, and bicycle paths to reduce the collision risks.

In one embodiment, the Device is programmed to record dangerous or negligent behavior by the Device's Defended XCraft Pilot who may dangerously or negligently be endangering other XCraft via aggressive or negligent operation of the Defended XCraft. The Device may be programmed to record highly safe diligent piloting behavior for the potential legal defense of the Defended XCraft Pilot following an accident or routine traffic enforcement incident.

By using the Enforcement Team embodiments, it may be possible to affect a mass social behavior change towards higher safety, more courtesy, and less illegal behavior to prevent injuries and death.

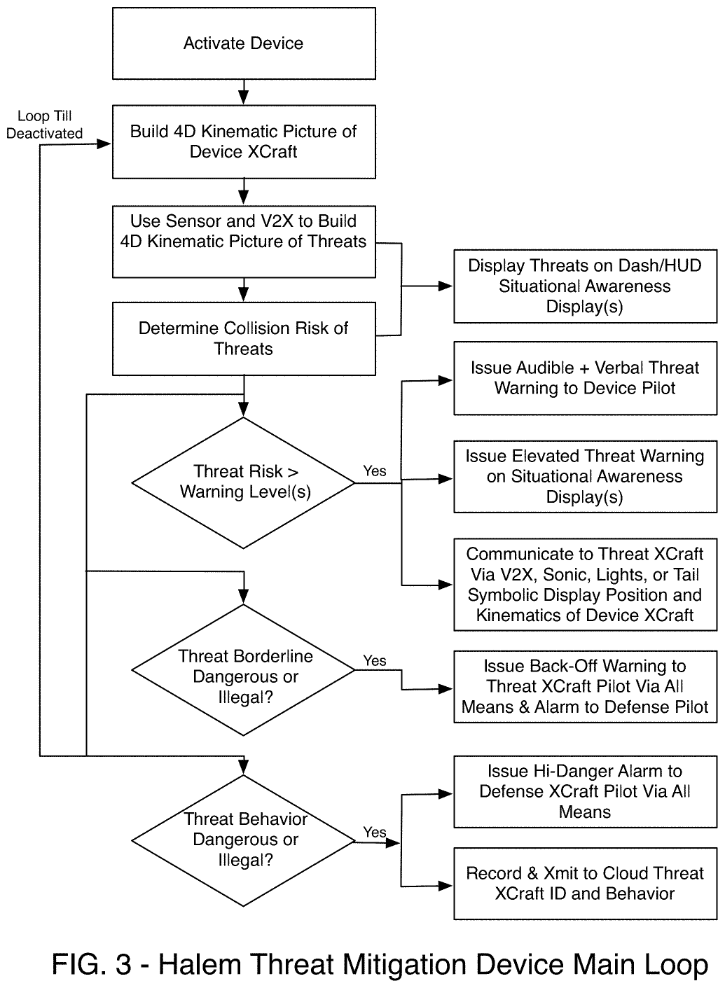

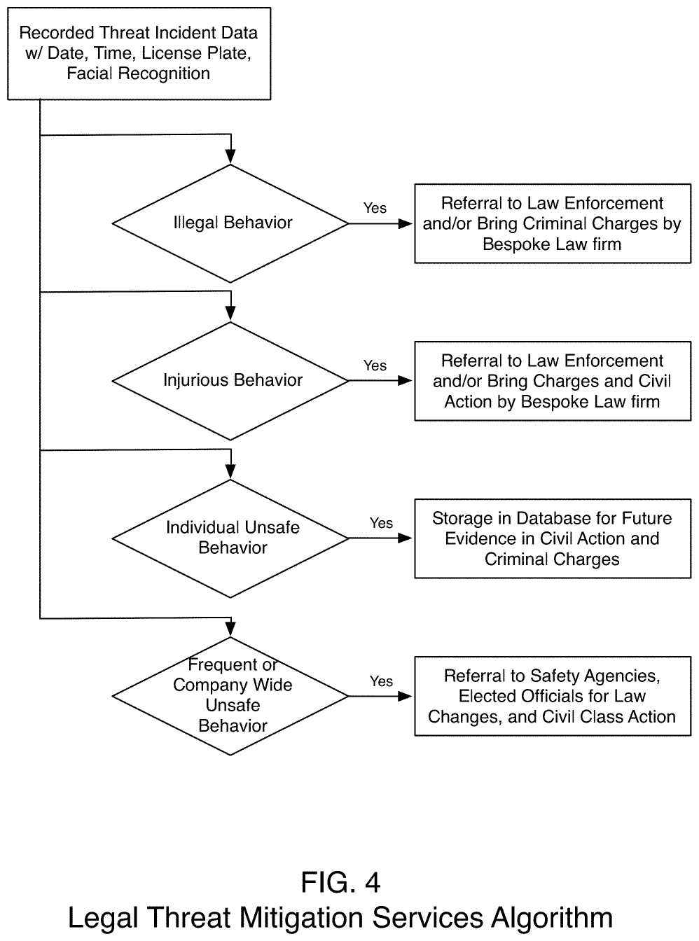

The processor which carries out the processing according to the present application operates according to the flowcharts of FIGS. 3 and 4.

FIG. 3 represents the threat mitigation main loop operated by the processor. At 300, the device is activated, by turning it on, thus starting the operation. At 305, the system builds a 4 dimensional kinematic picture of the device's Defended XCraft, using the cameras and other operations as described herein.

At 310, data from the Device's sensors and external V2X inbound data are integrated to provide additional information and accuracy to the kinematic picture. 315 uses all of this information to determine the collision risks of the different threats. Based on this collision risk, and the information obtained, the threats are displayed on the HUD 153 and/or Dash/Handlebar 150 display at flowchart point 320 to provide situational awareness.

325 determines if the threat risk is greater than a warning level, and if so issues a warning of one of multiple types. The warning types can include an audible plus verbal threat warning to the device XCraft's Pilot at 330, an elevated threat warning to the situational awareness display at 335, and communication to the Threat XCraft via the rear external display 140 and/or the front internal display 240 depending on the location of the Threat XCraft at flowchart point 340. If available, this information may also be transmitted to the Threat XCraft via a V2V comm link 260.

At 345, the system determines borderline dangerous or illegal operations, and issues a back off warning at 350. At 355 the system determines that the threat is actually dangerous or illegal (as compared with the borderline) at 345, and issues a high danger alarm at 355 to the pilot and starts recording and transmitting the data at 360.

The recorded threat incident data is made at 400 with the date, time, full kinematic situation, license plate and if available other ID information of Threat XCraft including facial imaging of Threat XCraft's Pilot. 405 determines if this is illegal behavior and at 410 this is referred to the law enforcement or private litigation team at 420. 415 determines if this is behavior that could lead to injury and again reports this information to the law enforcement team.

425 determines if there is individual unsafe behavior, and if so at 430 stores this in a database for future evidence in a possible future civil action and possible criminal charges. 435 determines if there is frequent or companywide unsafe behavior (e.g. a delivery company that always parks in the bike lane, or a delivery company that frequently drives with excessive speed near cyclists or pedestrians) by analyzing the database, and at 440 and reports that to government or law enforcement agencies as necessary.

In one embodiment, the operations can be carried out using a smart phone, with the cellphone's front facing camera and flash device mounted rearwards on the seat post of a bicycle. Additional phones or displays can be used to act as Tail Displays and Dash/Handle Bar mounted Pilot displays.

In one embodiment, the processor includes image recognition, feature detection, and motion detection to build a 3D+time Kinematics (“4D Kinematics”) of all objects in the field of view of any of the cameras or sensors described herein.

The processor runs software including computer instructions in any language that accomplishes its tasks to carry out actions by running on the processor. The Software may use, within modules, other software to accomplish defined tasks such as, without limitation image recognition, radar return processing, audio processing, Kinematic state estimation, or any other such task whether previously developed or to be developed in the future. The Software may use, without limitation, artificial intelligence (“AI”), neural networks of all kinds, Strong AI, Weak AI, Symbolic AI, Fuzzy systems and/or algorithms, evolutionary algorithms, genetic algorithms, heuristics, probability, statistics, Bayesian probability, filters including Kalman filters, moving averages, Markov models, Perceptrons or any other type of algorithm or computing mechanism. The Software may be programmed using analog computing or quantum computing means without defined Von Neumann instructions, whether in hardware or via digital simulation. The Software may be embodied within digital field programmable logic arrays (PLA's), gate arrays, customized digital or analog circuits, application specific integrated circuits (ASICs), CPUs, GPUs, quantum computing co-processing units, quantum computers, parallel processing, or any other means, without limitation to accomplish the task as described in the Possible Embodiments.

Display may be carried out on any kind of screen, or may also be displayed on a heads-up display (“HUD”) whether displayed on goggles, glasses, helmet mounted display, or displayed through the front windscreen of the XCraft, or a conventional dashboard or handlebar mounted display showing the location of all such threats. Other embodiments may have different versions of HUD or conventional displays.

What is claimed is:

1. A threat mitigation device, comprising:
a camera system, obtaining one or multiple camera views of areas around a Defended XCraft, said views including other Threat XCraft in the areas of the Defended XCraft;
plural different sensors, sensing plural different actions around the Defended XCraft;
a Pilot display displaying information to a Pilot of the vehicle;
a threat display, displaying information to at least one Pilot outside the vehicle; and
a processor, which receives information from the camera system, and the sensors, and determines a collision risk from Threat XCraft to the Defended XCraft, and if the collision risk is greater than a certain level, issues a warning to the Defended XCraft Pilot.

2. The system as in claim 1, where the threat risk greater than a warning level is classified as borderline dangerous or illegal, or definitely dangerous or illegal, and where the warning to the Defended XCraft Pilot is more serious for a more serious threat and the warning to the Threat XCraft Pilot is more serious for a more serious threat.

3. The system as in claim 2, wherein a threat risk which is definitely dangerous or illegal causes automatic recording of information about the threat.

4. The system as in claim 2, wherein the threat risk which is definitely dangerous is classified as being one of illegal behavior, injurious behavior, individual unsafe behavior or frequent or companywide unsafe behavior, and is as a consequence referred to government or legal agencies or teams, depending on a level of dangerousness of the behavior.

5. The system as in claim 1, wherein the threat display comprises a display on the exterior of the Defended XCraft, displaying information to another XCraft which is following the Defended XCraft.

6. The system as in claim 1, wherein the threat display comprises a display on the exterior of the Defended XCraft, displaying information to another XCraft which is moving near the Defended XCraft.

7. The system as in claim 1, wherein the sensors also include lidar/radar sensors.

8. The system as in claim 1, where the sensors also include microphone sensors.

9. The system as in claim 1, where the sensors also include sensors on external vehicles and infrastructure obtained via V2X.

10. The system as in claim 1, wherein the processor is in a cellular phone.

11. The system as in claim 1, wherein the processor is a threat mitigation computer, which receives information from the camera system and the sensors.

12. The system as in claim 1, wherein an external facing display displays an icon indicating to a user following the Defended XCraft that the user is being watched or recorded.

13. The system as in claim 12, wherein the icon is an icon indicating that recording is being carried out.

14. The system as in claim 12, wherein the icon contains a cropped photo of what the camera is actually recording.

15. The system as in claim 12, wherein the icon is a photo of the threat license plate number.

16. The system as in claim 1, wherein the processor accumulates information to predict and determine another vehicle hitting the Defended XCraft with their vehicle door.

17. The system as in claim 2, wherein the warnings are transmitted to the Defended XCraft Pilot via sound.

18. The system as in claim 2, where the warnings are transmitted to the Threat XCraft Pilot via loud sound.

19. The system as in claim 2, where the warnings are transmitted to the Threat XCraft via vehicle to vehicle (V2V) communications.
